(19) United States
(12) Patent Application Publication
(10) Pub. No.: US 2015/0249652 A1
(43) Pub. Date: Sep. 3, 2015

(54) ENABLING IMAGE BASED BROADCAST OF REVIEWS

(71) Applicant: David Sprague, Jupiter, FL (US)

(72) Inventor: David Sprague, Jupiter, FL (US)

(73) Assignee: REAL STRATEGIC INC., Jupiter, FL (US)

(21) Appl. No.: 14/194,877

(22) Filed: Mar. 3, 2014

(51) Int. Cl. H04L 29/06; G06F 3/0482; H04L 12/18

(52) U.S. Cl. CPC H04L 63/08; H04L 12/1813; G06F 3/0482

(57) ABSTRACT

A processor implemented method of enabling image broadcast of reviews includes connecting social media profiles of a user to a web portal, receiving image options at a user interface, displaying a list of reviews, accepting from the user a selection of from the list of reviews, generating a posting queue and publishing the selected review to the social media profile associated with the user in the form of an image.

### FIELD OF TECHNOLOGY

The present invention relates to a method, system and/or apparatus for image based broadcast of reviews.

### BACKGROUND

The advent of the World Wide Web (“Web”) has created a widespread phenomenon of review systems, which are essentially systems that support the reviews of particular items by large, self-selected groups of non-professional reviewers. This has the disadvantage of users being unable to present the right reviews to prospective future users of a system or service.

The prior art systems generally provide aggregation of user ratings, for example, an overall average user rating, or a ranking of a given item (book, movie, hotel, or restaurant, etc.) among a group of items. Some systems allow for multi-dimensional ratings or inputs.

There is lack of effective utilization and portrayal mechanism for users to show reviews for the users' products/services in a highlighted manner on social media.

### SUMMARY

Disclosed are a method, an apparatus and/or a system of image based broadcasts of user reviews.

In one aspect, a method includes connecting a social media profile associated with a user to a web portal and receiving image options at through a user interface. A list of reviews is displayed to the user through the user interface. The method further includes, accepting from the user a selection of review(s) from the list of reviews and in responsive to receipt of a command to share the selection at the first processor system, generating a posting queue. Additionally, responsive to receipt of a post now command, the method also includes generating and publishing the selected review(s) to the social media profile associated with the user.

In another aspect, a data processing device includes a processor that executes instructions and a memory having instructions when executed by the processor that causes the device to connect social media profile associated with a user to a web portal. The device includes a means to receive image options at a first processor system through a user interface associated with the web portal and display a list of reviews through the user interface. Further, the device accepts from the user a selection of review(s) from the list of reviews. The device in responsive to receipt of a command to share the selection at the first processor system, generates a posting queue and in responsive to receipt of a post now command, generates and publishes the selected review(s) to the social media profile(s) associated with the user.

The methods and systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic view of a system of broadcasting reviews onto social media through images, according to one or more embodiments.

FIG. 2 is a diagrammatic representation of a data processing system capable of processing a set of instructions to perform any one or more of the methodologies herein, according to one embodiment.

FIG. 3 is a process flow diagram detailing the operations of a method of image based broadcast of reviews, according to one or more embodiments.

Other features of the present embodiments will be apparent from the accompanying drawings and from the detailed description that follows.

### DETAILED DESCRIPTION

Example embodiments, as described below, may be used to provide a method, an apparatus and/or a system of image based broadcasting of customer reviews. Although the present embodiments have been described with reference to specific example embodiments, it will be evident that various modifications and changes may be made to these embodiments without departing from the broader spirit and scope of the various embodiments.

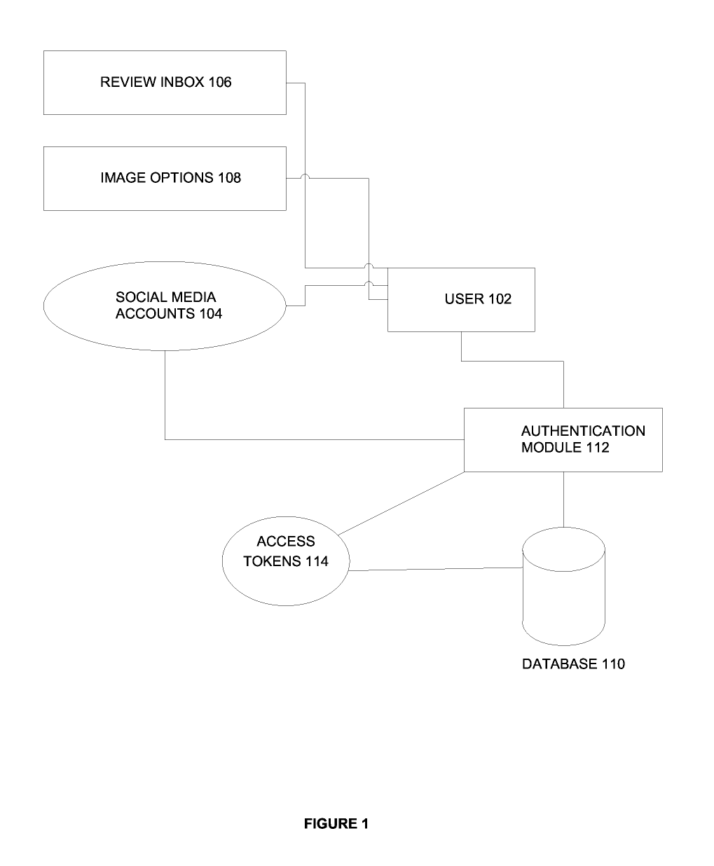

FIG. 1 is a block diagram detailing components involved in image based broadcasts of user reviews, according to one or more embodiments. In one or more embodiments, a system for image broadcasting of reviews through images may include a user 102 associated with a user interface coupled to a processor. Further, the user 102 may provide access details of social media account(s) 104. The access details provided by the user 102 may be processed by an authentication module 112. The authentication module 112 may be communicatively coupled to a computer database 110 that stores access tokens 114. The access details provided by the user 102 may be stored as the access tokens 114 in the database 110.

In one or more embodiments, after the user 102 provides authentication details the user 102 may be offered image options 108. The image options 108 may be one of an image, a logo and a name. In an example embodiment, a user may upload a branding image, a company logo and name.

In an example embodiment, a processor implemented method of enabling image based broadcast of reviews may include connecting social media profiles of a user to a web portal and in response, receiving image options at a user interface. A list of reviews may be displayed on a user interface. A selection of from the list of reviews may be accepted from the user. In response to the selection, a posting queue may be generated and displayed on the user interface. The selected review may be published in the form of an image to the social media profile associated with the user.

In one or more embodiments, a processor implemented of image based user review broadcasting may include connecting a social media profile associated with a user to a web portal. In response to the connection, a user interface may display image options at a first processor system connected to the web portal. A list of reviews may be displayed to the user through the user interface. A selection of review(s) may be accepted from the list of reviews. Responsive to receipt of a command to share the selection at the first processor system, a posting queue may be generated. Further, responsive to receipt of a post now command, the selected review(s) may be generated and published in the form of an image to the social media profile associated with the user.

In one or more embodiments, the posting queue may be generated to a log table associated with a memory storage. In one or more embodiments, authentication access to social media profile may be recorded in the process of connecting to the web portal. Upon successful authentication of the social media profile(s), an account access token may be received.

In one or more embodiments, the image options may be one or more of an image, a logo and a name. Further, the image may refer to branding image that an organization uses. The logo and name may refer to the organization's logo and name.

In one or more embodiments, the account access token may be utilized for publishing the selected review(s). Further, the image may be associated with an image format. The image formats may be one of JPEG/JFIF, JPEG 2000, Exif, TIFF, RAW, PNG, GIF, BMP, PPM, PGM, PBM, PNM, WEBP, CGM, SVG, PNS, JPS, MPO as well as derivatives and combinations of these types.

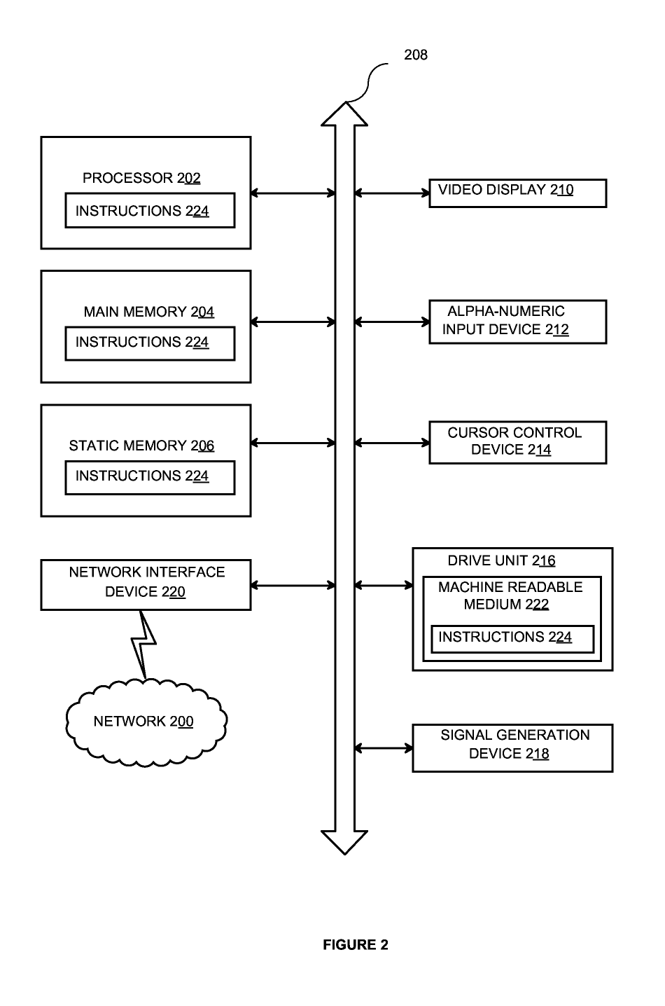

FIG. 2 is a diagrammatic representation of a data processing system capable of processing a set of instructions to perform any one or more of the methodologies herein, according to an example embodiment. FIG. 2 shows a diagrammatic representation of machine in the example form of a computer system 200 within which a set of instructions, for causing the machine to perform any one or more of the methodologies discussed herein, may be executed. In various embodiments, the machine operates as a standalone device and/or may be connected (e.g., networked) to other machines.

In a networked deployment, the machine may operate in the capacity of a server and/or a client machine in server-client network environment, and or as a peer machine in a peer-to-peer (or distributed) network environment. The machine may be a personal-computer (PC), a tablet PC, a set-top box (STB), a Personal Digital Assistant (PDA), a cellular telephone, a web appliance, a network router, switch and or bridge, an embedded system and/or any machine capable of executing a set of instructions (sequential and/or otherwise) that specify actions to be taken by that machine. Further, while only a single machine is illustrated, the term “machine” shall also be taken to include any collection of machines that individually and/or jointly execute a set (or multiple sets) of instructions to perform any one and/or more of the methodologies discussed herein.

The example computer system 200 includes a processor 202 (e.g., a central processing unit (CPU) a graphics processing unit (GPU) and/or both), a main memory 204 and a static memory 206, which communicate with each other via a bus 208. The computer system 200 may further include a video display unit 210 (e.g., a liquid crystal displays (LCD) and/or a cathode ray tube (CRT)). The computer system 200 also includes an alphanumeric input device 212 (e.g., a keyboard), a cursor control device 214 (e.g., a mouse), a disk drive unit 216, a signal generation device 218 (e.g., a speaker) and a network interface device 220.

The disk drive unit 216 includes a machine-readable medium 222 on which is stored one or more sets of instructions 224 (e.g., software) embodying any one or more of the methodologies and/or functions described herein. The instructions 224 may also reside, completely and/or at least partially, within the main memory 204 and/or within the processor 202 during execution thereof by the computer system 200, the main memory 204 and the processor 202 also constituting machine-readable media.

The instructions 224 may further be transmitted and/or received over a network 226 via the network interface device 220. While the machine-readable medium 222 is shown in an example embodiment to be a single medium, the term “machine-readable medium” should be taken to include a single medium and/or multiple media (e.g., a centralized and/or distributed database, and/or associated caches and servers) that store the one or more sets of instructions. The term “machine-readable medium” shall also be taken to include any medium that is capable of storing, encoding and/or carrying a set of instructions for execution by the machine and that cause the machine to perform any one or more of the methodologies of the various embodiments. The term “machine-readable medium” shall accordingly be taken to include, but not be limited to, solid-state memories, optical and magnetic media, and carrier wave signals.

For example, social media platforms may be social networking services such as Facebook™, Twitter™, and Pinterest™. In one or more embodiments, social networking services may require users to register before using the social networking services, after which the users may create a personal profile, add other users as friends, exchange messages, and receive automatic notifications when the users update the personal profile. Additionally, users may join common-interest user groups, organized by workplace, school and/or college and/or university, or other characteristics, and categorize friends into lists such as “People From Work” or “Close Friends”. Further, social network services may allow users to follow activities and posts of other users.

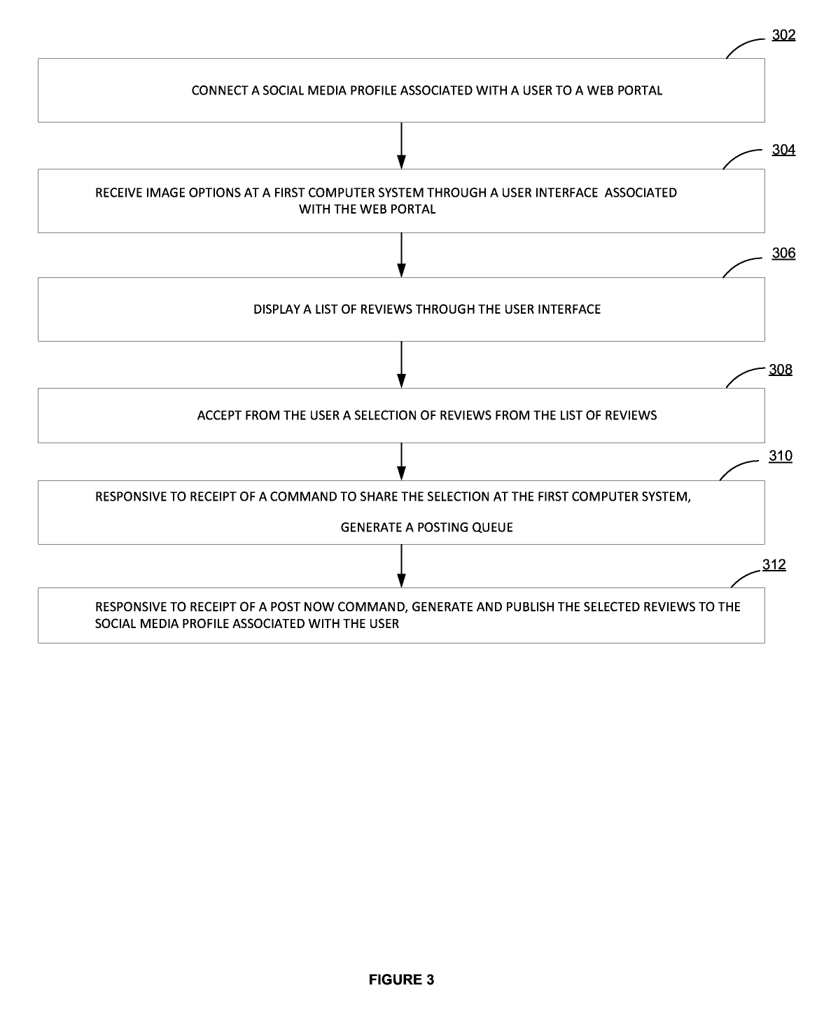

FIG. 3 is a process flow diagram detailing the operation of a method of posting review(s) through images onto social media platforms. Posting image based reviews onto social media platforms may include a step of providing a connection to social media profiles associated with the user to the web portal 302. The web portal may be provided with access to the user's personal information such as messages, posts onto social platform, and images. Further, the method may include image options that may be received at a first computer system through a user interface associated with the web portal 304. Further, displays a list of reviews through the user interface 306. Still further, accepting from the user a selection of reviews from the list of reviews 308. A posting queue may be generated in response to a command from the user to share 310. Also, in response to a post now command, the selected reviews may be generated as images and posted onto social media profile(s) 312. In one or more embodiments, a social media profile may be associated with the user, organization that a user may have affiliation to, group of individuals and/or organization.

In an example embodiment, reviews from users may be collected and/or scrapped from multiple websites. The reviews may be stored in a computer database. The reviews may be presented to a user of an image based review aggregation and publishing system. The user selects a set reviews that the user wants to be present in a review image. The review image may be a aggregation of multiple text based reviews in the form of an image. The review image may include one of a reviewer name, review website, date, website, rating, and feedback. Further, the review image may be posted to one or more social media service providing sites.

In another example embodiment, reviews may be collected from one or more websites such as Yelp, and Urbanspoon. Further, reviews may be collected from social media sites such as Twitter™.

In an example embodiment, reviews of a service may be collected from one or more websites and stored onto a computer database. Further, the collected reviews may be aggregated into a review image. The review image may be posted onto a social media site.

In an example embodiment, reviews for a service and/or product may be collected. The collected review may include one of a reviewer detail, review rating, date of review, time of review, review site, and contact detail of the reviewed service and/or product. The collected reviews may be added onto a review directory. A user may be presented with the list of collected reviews to choose from. The chosen reviews may be added to an image. The image formed from the chosen reviews may include one of a reviewer detail, review rating, date of review, time of review, review site, and contact detail of the reviewed service and/or product. The image formed from the chosen review(s) may be posted onto a social media service such as Facebook™, Twitter™ and/or Pinterest™.

The collection of reviews may be done through one of scraping off multiple websites, receiving reviews through email, Multimedia messaging service, instant messaging services and so on. In one or more embodiments, a review directory may be a listing of all reviews pertaining to a service and/or product. In one or more embodiments, a review directory may be a certain section of a social media service dedicated to the service and/or product e.g Product page on Facebook™.

In an example embodiment, reviews for a service and/or product may be collected. The collected review may include one of a reviewer detail, review rating, date of review, time of review, review site, and contact detail of the reviewed service and/or product. The collected reviews may be added onto a review directory. A user may be presented with the review directory to choose from. The chosen reviews may be added to an image. The image formed from the chosen reviews may include one of a reviewer detail, review rating, date of review, time of review, review site, and contact detail of the reviewed service and/or product. The image formed from the chosen review may be posted onto a social media service such as Facebook™, Twitter™ and/or Pinterest™.

In one or more embodiments, a processor implemented method of posting image based reviews onto social media site(s) may include aggregating reviews for one of a service and a product from websites through the processor. The aggregated reviews may be collected onto a computer database. A user may be presented the aggregated reviews from websites through a user interface at a processor driven computer display. One or more social media profiles associated with the user may be connected to the web portal. and the review image may be posted onto a social media site through the web portal.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry, firmware, software or any combination of hardware, firmware, and software (e.g., embodied in a machine readable medium). For example, the various electrical structure and methods may be embodied using transistors, logic gates, and electrical circuits (e.g., application specific integrated (ASIC) circuitry and/or in Digital Signal Processor (DSP) circuitry).

In addition, it will be appreciated that the various operations, processes, and methods disclosed herein may be embodied in a machine-readable medium and/or a machine accessible medium compatible with a data processing system (e.g., a computer devices), and may be performed in any order (e.g., including using means for achieving the various operations). Various operations discussed above may be tangibly embodied on a medium readable through the retail portal to perform functions through operations on input and generation of output. These input and output operations may be performed by a processor. The medium readable through the retail portal may be, for example, a memory, a transportable medium such as a CD, a DVD, a Blu-ray™ disc, a floppy disk, or a diskette. A computer program embodying the aspects of the exemplary embodiments may be loaded onto the retail portal. The computer program is not limited to specific embodiments discussed above, and may, for example, be implemented in an operating system, an application program, a foreground or background process, a driver, a network stack or any combination thereof. The computer program may be executed on a single computer processor or multiple computer processors.

Accordingly, the specification and drawings are to be regarded in an illustrative rather than a restrictive sense.

What is claimed is:

1. A processor implemented method comprising:
connecting at least one social media profile associated with a user to a web portal;
receiving image options at a first processor system through a user interface associated with the web portal;
displaying a list of reviews through the user interface;
accepting from the user a selection of at least one review from the list of reviews;
responsive to receipt of a command to share the selection at the first processor system, generating a posting queue; and
responsive to receipt of a post now command, generating and publishing the selected at least one review to the at least one social media profile associated with the user.

2. The processor implemented method of claim 1, further includes:
generating the posting queue to a log table associated with a memory storage.

3. The processor implemented method of claim 1, further includes:
authenticating the at least one social media profile in the process of connecting to the web portal.

4. The processor implemented method of claim 1 further includes:
upon successful authentication of the at least one social media profile, receiving an account access token.

5. The processor implemented method of claim 1 further includes:
wherein the image options are at least one of an image, a logo and a name.

6. The processor implemented method of claim 1 further includes:
utilizing the account access token for publishing the selected at least one review.

7. The processor implemented method of claim 1, wherein the image is associated with an image format.

8. The processor implemented method of claim 1, wherein the image format is selected from a set of image formats including: JPEG/JFIF, JPEG 2000, Exif, TIFF, RAW, PNG, GIF, BMP, PPM, PGM, PBM, PNM, WEBP, CGM. SVG, PNS, JPS, MPO as well as derivatives and combinations of these types.

9. A data processing device comprising:
a processor that executes instructions;
a memory having instructions when executed by the processor, that causes the data processing device to:
connect at least one social media profile associated with a user to a web portal;
receive image options at a first processor system through a user interface associated with the web portal;
display a list of reviews through the user interface;
accept from the user a selection of at least one review from the list of reviews;
responsive to receipt of a command to share the selection at the first processor system, generate a posting queue; and
responsive to receipt of a post now command, generate and publish the selected at least one review to the at least one social media profile associated with the user.

10. The device of claim 9, wherein the posting queue is generated and stored into to a log table associated with a memory storage.

11. The device of claim 9, wherein the at least one social media profile is authenticated in the process of connecting to the web portal.

12. The device of claim 9, wherein upon successful authentication of the at least one social media profile, an account access token is received.

13. The device of claim 9, wherein the image options are at least one of an image, a logo and a name.

14. The device of claim 9, wherein the account access token is utilized for publishing the selected at least one review as an image.

15. The device of claim 14, wherein the image is associated with an image format.

16. The device of claim 15, wherein the image format is selected from a set of image formats including: JPEG/JFIF, JPEG 2000, Exif, TIFF, RAW, PNG, GIF, BMP, PPM, PGM, PBM, PNM, WEBP, CGM. SVG, PNS, JPS, MPO as well as derivatives and combinations of these types.

17. A processor implemented method comprising:
aggregating reviews for at least one of a service and a product from websites through the processor onto a web portal;
collecting the aggregated reviews onto a computer database associated with the web portal;
presenting a user the aggregated reviews from websites through a user interface at a processor driven computer display;
accepting from the user a selection of reviews to be added onto a review image,
wherein the selection is a subset of the aggregated reviews;
connecting at least one social media profile associated with a user to the web portal; and
posting the review image onto a social media site through the processor.
